(19) United States
(12) Patent Application Publication
(10) Pub. No.: US 2003/0067704 A1
(43) Pub. Date: Apr. 10, 2003

(54) Data storage media having integrated environmental sensor

(76) Inventors: Arthur Cheumin Woo, Bristol (GB); Nicholas John Iles, Chester (GB)

Correspondence Address: LOWE HAUPTMAN GILMAN & BERNER, LLP, Suite 300, 1700 Diagonal Road, Alexandria, VA, 22314, US

(21) Appl. No.: 10/252,109

(22) Filed: Sep. 23, 2002

(30) Foreign Application Priority Data
Sep. 21, 2001 (GB) 0122908.7

(51) Int. Cl. G11B 19/02; G11B 27/36

(52) U.S. Cl. 360/69; 360/31

(57) ABSTRACT

There is disclosed a data storage media cartridge comprising: a casing; a data storage media; and a sensor device capable of sensing an environmental parameter to which said media cartridge is exposed.

### FIELD OF THE INVENTION

The present invention relates to the field of data storage media.

### BACKGROUND TO THE INVENTION

Tape data storage devices for storage of large amounts of back-up data are well known in the art. Examples of known tape data storage devices comprise the Hewlett Packard series range of products, capable of storing between 4 Gbytes and 30 Gbytes of data, using one or a plurality of individual tape data storage media supplied in removable cartridge format. Formats include DDS (digital data storage) and LTO (linear tape open).

Tape data storage systems having various media cartridge formats are available, including single reel cartridge systems, in which a length of magnetic tape data storage media is wound onto a single reel within a cartridge systems, or twin reel cartridges, in which a length of tape data storage medium is wound between first and second reels within a cartridge.

Conventional tape data storage media are designed to operate with specified performance provided they are kept within environmental limits which are specified by a manufacturer. Operation of a media cartridge outside the specified environmental ranges may lead to malfunctioning of the cartridge and/or loss of data on the cartridge.

Environmental conditions which may be specified by a manufacturer include:

a temperature range between a maximum and minimum operating temperature which the cartridge is designed to operate within;

a maximum magnetic field within which the cartridge can operate;

a maximum humidity which the cartridge may be exposed to;

a maximum dust environment, i.e. number and size of particles and foreign bodies, which the cartridge may operate within;

a general cleanliness of environment, including freedom from grease, fluids, solvents and the like; and

mechanical handling criteria, for example, a shock criteria, for example a maximum height from which it is safe to drop a cartridge, and for a maximum loading which can be placed on the cartridge casing.

A common problem with tape drive data storage devices is the requirement for a service call out or return of the unit to manufacturer for service, when a fault on the tape drive is reported by a user. In many cases, upon testing it turns out that the tape drive itself is not malfunctioning, but that a fault has occurred with a media cartridge due to mistreatment of the cartridge or operation of the cartridge outside its specified environmental conditions. Therefore, a fault in a media cartridge can lead to an unnecessary service call out for a tape drive, or downtime on a tape drive whilst it is returned to a manufacturer for testing or service.

Since faults on tape drives and media cartridges can be intermittent, it is often difficult to distinguish between a fault on a media cartridge, and a fault on a tape drive device. For tape drive devices operating a plurality of media cartridges, the problem is compounded. Where several cartridges are operated at once in a tape drive, the probability of encountering a malfunctioning media cartridge are increased.

Although the above problems are prominent in particular in tape drive units and tape media cartridges, the problem of faulty data storage media cartridges is generic across many types of media cartridge including, but not limited to, magnetic random access memory (MRAM) removable cartridges, and removable hard disk units.

### SUMMARY OF THE INVENTION

According to a first aspect of the present invention there is provided a data storage media cartridge comprising:

a casing;

a data storage media; and

a sensor device capable of sensing an environmental parameter to which said media cartridge is exposed.

Other features of the present invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically in perspective view, a tape data storage media cartridge of the single reel type according to a first specific embodiment of the present invention;

FIG. 2 illustrates schematically in cut away plan view, the media cartridge of FIG. 1, showing an internal environmental dust sensor;

FIG. 3 illustrates schematically in cross section, part of a casing of the media cartridge of FIGS. 1 and 2, showing the dust sensor;

FIG. 4 illustrates schematically the section of FIG. 3, having accumulated dust;

FIG. 5 illustrates schematically a visual reference device according to a second specific embodiment of the present invention for assessing a condition of a media cartridge exposed to a dust environment;

FIG. 6 illustrates schematically in cut away view, construction of the reference device of FIG. 5;

FIG. 7 illustrates schematically a tape drive unit according to a third specific embodiment of present invention, capable of reading a condition of a media cartridge;

FIG. 8 illustrates schematically an internal capstan and roller mechanism of the tape drive of FIG. 7, and showing a read device for reading a media cartridge;

FIG. 9 illustrates schematically a read channel of the tape drive unit of FIGS. 7 and 8;

FIG. 10 illustrates schematically a media cartridge comprising an active sensor component according to a fourth specific embodiment of the present invention, in cut away view;

FIG. 11 illustrates schematically components of an active sensor component comprising the media cartridge of FIG. 10;

FIG. 12 illustrates schematically one embodiment of a tribo electric device, for measuring environmental particles;

FIG. 13 illustrates schematically a first mode of operation of the media cartridge of FIG. 10;

FIG. 14 illustrates schematically a second mode of operation of the media cartridge of FIG. 10, for sending data from the media cartridge of FIG. 10;

FIG. 15 illustrates schematically a mode operation of a tape drive unit for interrogating a media cartridge comprising an active sensor component as described with reference to FIG. 10;

FIG. 16 illustrates schematically a further sensor component, having a plurality of indicator warning devices, according to a fifth specific embodiment of the present invention;

FIG. 17 illustrates schematically a sensor component having a plurality of warning indicator devices, and an on board memory device according to a sixth specific embodiment of the present invention; and

FIG. 18 illustrates schematically a logical layout for storage of data describing out of bound environmental parameter conditions, stored in a memory device of the sensor component, which can be downloaded to a tape drive unit when a media cartridge is inserted in the tape drive unit.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification, the term “data storage device” includes a device capable of reading and/or writing data to a data storage media cartridge. A data storage device may be capable of engaging a data storage media cartridge for transfer of data between the data storage device and the data storage media cartridge. A data storage device may be capable of transferring data with a plurality of individual data storage media cartridges, either in parallel at a same time, and/or sequentially one after another.

In this specification the term “data storage media cartridge” includes any data storage media which, in normal use, provides for self contained storage of data, and can be stored or kept independently of a data storage device. Data may be read and/or written to a data storage media cartridge using a data storage device. The data storage media cartridge may be engageable with one or more different data storage devices at different times, and may be removable from each data storage device. The term media cartridge is to be construed as having a meaning equivalent to a data storage media cartridge.

One object of specific implementations according to the present invention is to enable a user to distinguish between a fault on a data storage device, for example, a tape drive unit and a faulty media cartridge, thereby reducing the need for service call out or downtime on a data storage device.

Another object of specific embodiments, is to provide a media cartridge of which a condition and/or history can be assessed, and particularly although not exclusively, previous exposure to environmental conditions.

In specific implementations according to the present invention, a media cartridge includes one or more environmental sensor devices responsive to a media cartridge being exposed to an environmental condition outside of a specified environmental conditions.

In certain embodiments, the environmental sensor is a passive sensor, capable of detecting changes in environmental conditions without the need for a power supply. In one preferred arrangement, the sensor provides to a viewer of the sensor a visual indication responsive to an environmental measurand having been encountered which is outside a specified limit.

In other embodiments, the sensor device is active, being powered by a power supply. A data output of the sensor device is preferably stored in a memory device provided within the media cartridge.

In one embodiment, a tape drive data storage device is provided with a read channel for reading one or a plurality of sensors mounted on a media cartridge, and for displaying an alert message if a media cartridge has been found to have been exposed to an out of specification environment.

The following description is directed to a specific tape data storage media cartridge and tape drive unit. However, it will be understood by the person skilled in the art, that the features and methods described herein are applicable to a range of types of data storage media cartridges including, but not limited to, removable magnetic random access memory (MRAM) modules, removable hard disk drives, removable solid state non volatile memories, removable PROM cartridges, removable EPROM cartridges and removable EEPROM cartridges. Data storage devices for reading or writing to these different media cartridge types, having appropriate modification similar to the embodiments described herein, will be readily apparent to those skilled in the art.

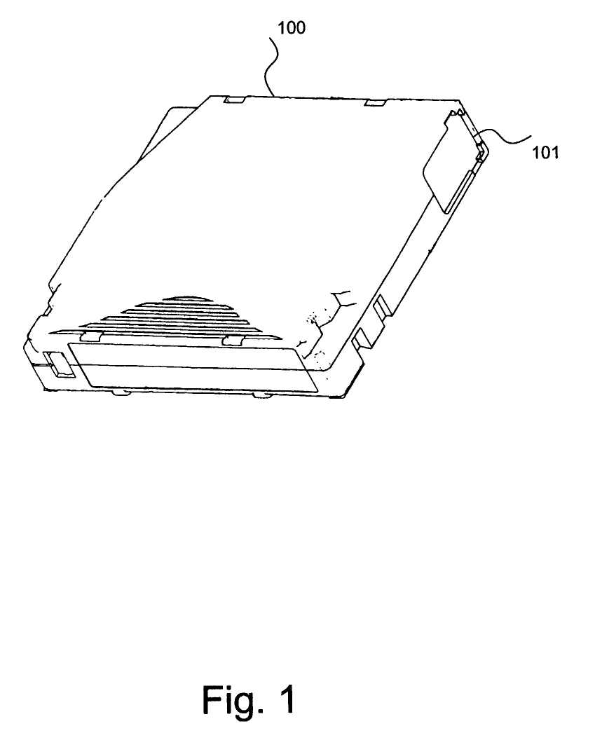

Referring to FIG. 1 herein, there is illustrated schematically a tape data storage media cartridge of the single reel type. The cartridge comprises a casing 100 containing a single reel upon which is wound an elongated magnetic tape data storage medium. The tape data storage medium can be extracted from the cartridge through an aperture 101, in order to wind the tape into a tape drive unit.

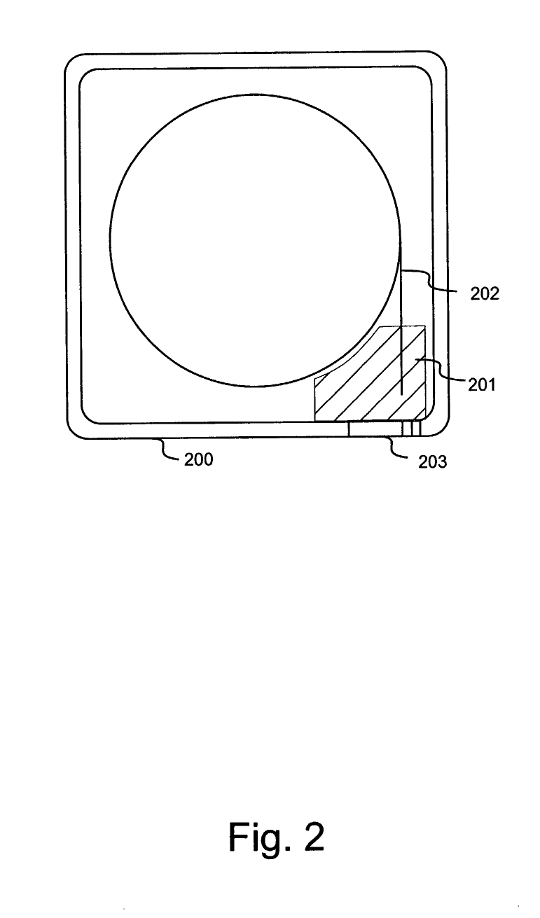

Referring to FIG. 2 herein, there is illustrated schematically the cartridge of FIG. 1 in plan cut away view. Cartridge casing 200 has an interior surface region 201 coated with an adhesive reflective material. The surface region 201 is position inside the cartridge, at a position that can be visually inspected from outside the cartridge, and at a position within the cartridge which does not interfere with operation of extension of elongated magnetic tape data storage medium 202 into and out of the cartridge. In the best mode, the surface region 201 is situated near aperture 203 through which the magnetic tape passes when drawn into a tape drive unit. As the media cartridge is exposed to environmental conditions, including conditions within a tape drive unit, dust particles may accumulate and adhere to the adhesive coating. The reflective properties of the adhesive coating change as dust accumulates.

Typically, the adhesive coating is highly reflective when newly manufactured. The adhesive coating comprises an area of reflective material, e.g. silvered or otherwise reflective material, covered with a layer of transparent or translucent adhesive. As dust particles collect on the adhesive coating, transmission of light to the underlying reflective surface is hindered, resulting in an overall loss of reflectivity of the surface when viewed from outside the cartridge. In an alternative embodiment, the coating is a homogenous mixture of reflective particles and transparent or translucent adhesive. Transparent adhesive materials and coatings, and reflective particles are well known in the art. A suitable reflective adhesive coating is selected, having properties such that the coating remains adhesive throughout the expected lifetime of the media cartridge, and reflectivity properties are selected such that, with accumulation of dust, a visual difference in reflectivity can be assessed by human observer, or such that changes in reflectivity can be measured by an external read sensor.

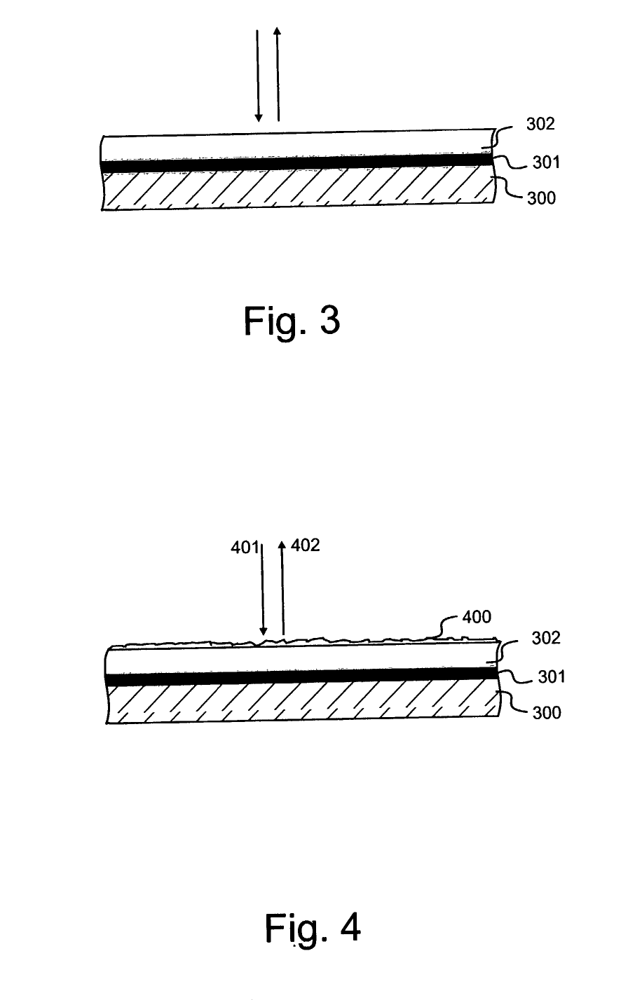

Referring to FIG. 3 herein, there is illustrated schematically in cut away section, part of the casing of the media cartridge of FIGS. 1 and 2 having the reflective adhesive coating. The casing 300 comprises a plastics sheet substrate material, coated with a reflective layer 301, for example a metallic deposit, which may be sputtered, sprayed, or electro coated onto the interior of plastics casing 300. On top of the reflective layer 301 is applied a transparent or translucent adhesive layer 302. In one embodiment, the transparent layer/translucent layer 302 allows passage of light in the visible range, thereby allowing visual inspection of the reflective layer. In other embodiments, the transparent layer 302 is transparent only at pre-selected frequencies. For example, a material which is transparent at a light wave length corresponding to a red laser (633 nm) can be provided, thereby allowing a commercially available visible diode laser to be used to automatically assess the reflectivity of the overall coating. Similarly, the transparent layer may be transparent at infrared frequency, (for example 814 nm) allowing an invisible infrared diode laser to assess the reflectivity of the coating.

The adhesive reflective coating of the first embodiment provides a cumulative and historical measurement of dust conditions to which a media cartridge has been subjected, either inside, or outside a tape drive unit casing. The media cartridge may have been used within several different tape drive units, and/or kept in storage. The adhesive reflective surface therefore provides a measure of a current condition of a media cartridge, rather than a measure of conditions within any particular tape drive which the cartridge has experienced, since the reflectivity condition of the reflective adhesive surface is representative of a cumulative exposure to a dust environment experienced by the media cartridge itself. In general interior components of the cartridge, including a surface of the tape medium itself, and an interior surface of the cartridge not having the reflective adhesive coating is less susceptible to dust collection than the adhesive reflective coating itself, since those other internal surfaces are in general non adhesive.

Referring to FIG. 4 herein, there is illustrated the coating as shown in FIG. 3, after a period of usage of the media cartridge. A layer of dust and particles 400 has built up, adhering to the adhesive surface 302. Light rays 401 incident on the surface 302, are reflected as rays 402 having reduced intensity compared to a clean layer.

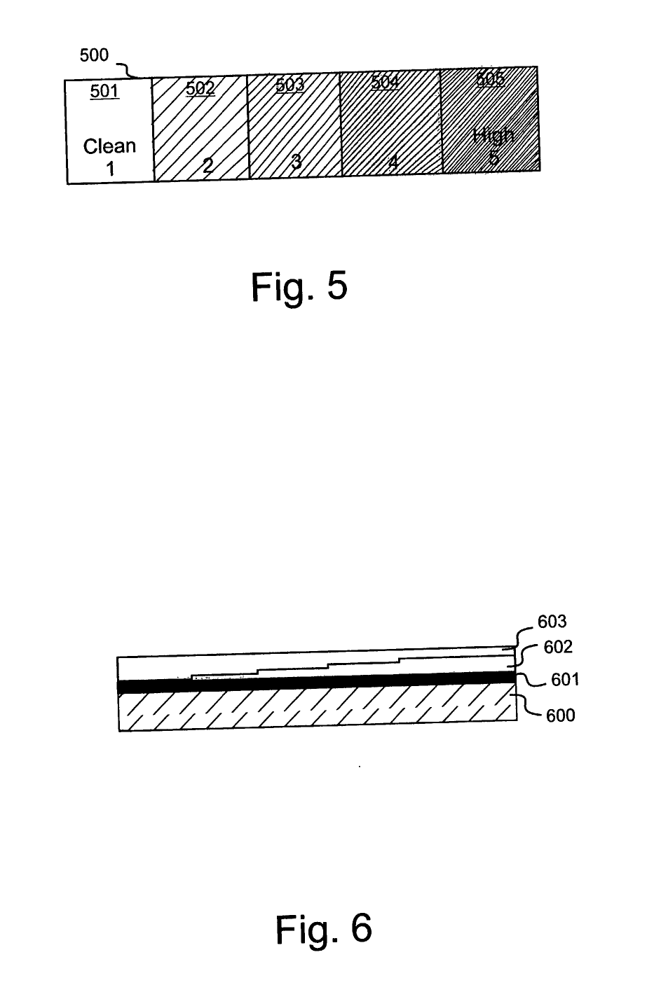

Referring to FIG. 5 herein, there is illustrated schematically a reference, device 500 according to a second specific embodiment of the present invention which can be provided in order to allow a human user to visually assess the level of dust to which a cartridge has been exposed, by visual comparison of the surface inside the cartridge, with the reference device 500. The reference device 500 comprises an elongate strip of sheet material, having a reflective coating and an adhesive coating, similarly as applied to the cartridge casing. The strip is divided into several regions 501-505, each having a different reflectivity. One method of manufacturing the different reflectivity regions is that each region has applied, under controlled conditions at manufacture, varying levels of dust or equivalent particles. The strip is then sealed with a transparent non adhesive layer, for example a transparent plastics material.

The reflective surface of the strip preferably has printed a scale, for example the numbers 1 to 5, allowing a human user to refer to the level of reflectivity selected from the device to correspond with the reflective condition of the adhesive reflective material within the media cartridge.

Each region, ranging from a dust-free region 501 to a heavily dust contaminated region 505 can be visually compared by a human user with the reflective surface within a cartridge, so that a human user can make an approximate assessment of the level of dust contamination within the cartridge, and make a decision to replace or reject the cartridge based upon the amount of dust within the cartridge.

The reference device 500 can be calibrated by exposing, under laboratory test conditions, a cartridge to various calibrated levels of atmospheric dust for measured time periods, in order to measure the build up of dust inside the cartridge, and then compare the performance of cartridges with various dust levels in terms of mis-read bytes and lost data, to obtain a safe operating range for dust exposure for the cartridge. Therefore, a user can be provided with a reference strip 500 showing a plurality of regions, for example regions 501-504 having progressively increasing levels of dust and correspondingly lower levels of reflectivity, within which the cartridge is within environmental limit. Region 500 has a final level of reflectivity 505, where the cartridge is deemed to have encountered a dust environment which is out of specified limits, and therefore indicates a high probability of the cartridge being faulty.

Referring to FIG. 6 herein, there is shown in cross section, one possible construction of the layers of the reference device 500. Device 500 comprises (1) a base sheet 600, made, for example, of a sheet plastics material; (2) a reflective layer 601; (3) a dust layer 602 having variously graded regions of dust thickness; and (4) a transparent sealant layer 603.

In another embodiment, the reference device can be a simple printed substrate strip, e.g. made of plastics or paper material, where the regions of differing reflectivity are printed on to the substrate.

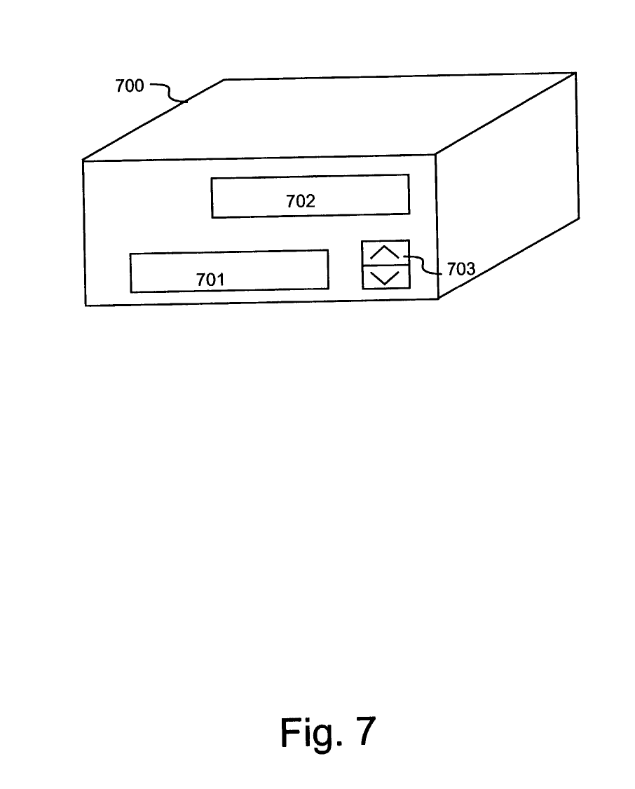

Referring to FIG. 7 herein, there is illustrated schematically in external perspective view, a further tape drive unit capable of automatically reading a sensor device contained within a media cartridge, when the media cartridge is located in the tape drive unit. The tape drive unit comprises a casing 700, having a port 701, for accepting a media cartridge. Port 701 includes (1) a device for reading an environmental sensor device located inside the cartridge casing; (2) display device 702, for example a liquid crystal display, for generating messages describing a condition of the cartridge; and (3) a keypad 703. The messages can be generated by entering a displayed menu, in response to keypad inputs by the user.

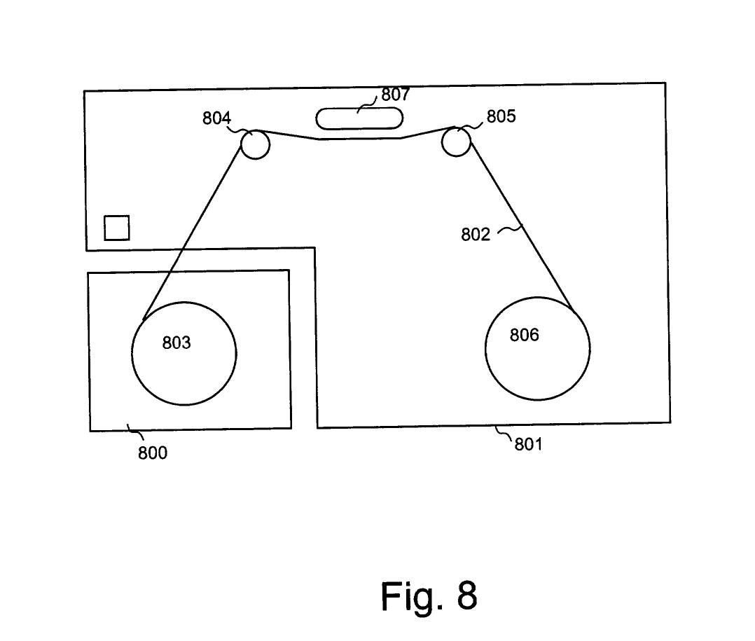

Referring to FIG. 8 herein, there is illustrated schematically a cartridge 800 inserted into a tape data storage device 801. In FIG. 8 is shown a length of tape data storage medium 802 that is wound from an internal supply reel 803 of the cartridge. Medium 802 extends through a series of rollers 804, 805 onto a second take-up reel 806 comprising the tape data storage device. The tape data storage device comprises a read/write head 807 over which the tape is drawn, in forward and reverse directions, to apply read or write operations of user data to the tape.

Typically, the tape drive controls the movement of the tape over the write head to record data onto the magnetic tape, and over the read head to generate an electrical signal from which the stored data can be reconstructed. Commonly, the read and write heads are combined into a single read/write head. The speed of the tape across the read/write head is controlled by the speed of rotation of the internal supply reel 803 of the cartridge, and by the speed of the take-up reel 806 of the tape drive.

The tape drive is provided with a reading device 808 shown schematically in FIG. 8, which in practice is physically mounted within a drive mechanism, such that it is placed adjacent the aperture within the media cartridge casing, enabling a line of sight between the reading device and the reflective coating when the cartridge is installed in the tape drive unit. The read device 808 sends a light (optical) signal, for example a modulated diode laser signal onto the reflective adhesive surface of the media cartridge. The light is reflected from the adhesive surface. The light is sensed by a sensor, for example a diode sensor, comprising the read device. The intensity of the reflected light varies as the dust condition of the reflective adhesive coating on the media cartridge changes. For a high dust level, the intensity of the returned reflected light is low and for a clean reflective adhesive surface, the reflected light has a strong intensity that is sensed by the sensor device.

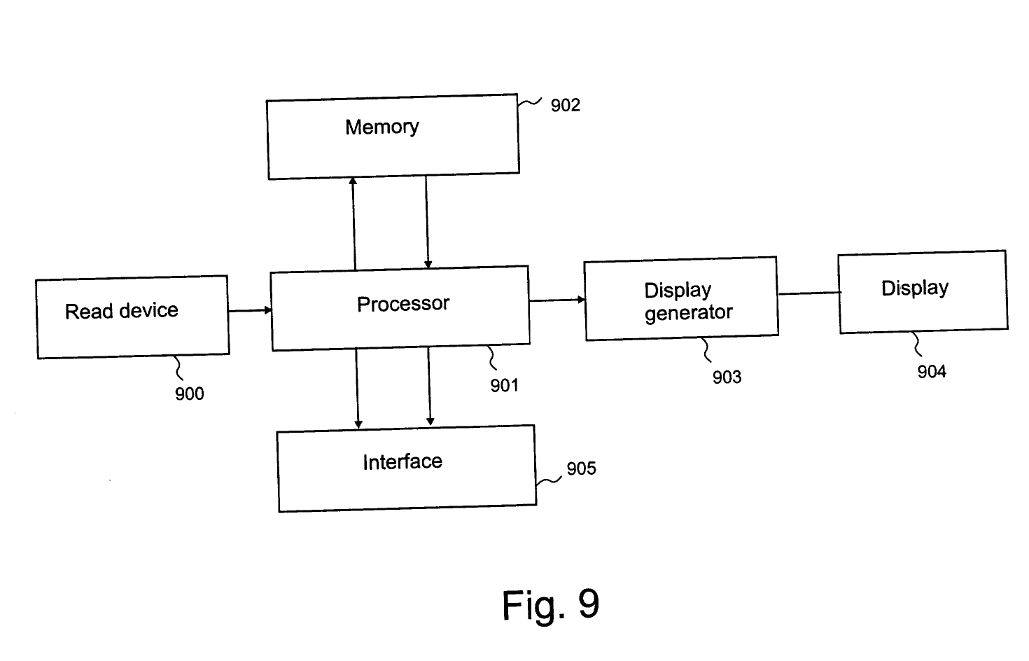

Referring to FIG. 9 herein, there is illustrated schematically a read channel provided within a tape data storage device drive unit. The read channel comprises (1) a read device 900 for reading reflective light from a reflective surface; (2) a data processor 901 and associated memory 902, that is a volatile and/or non volatile memory, for analyzing the reflectivity of a reflective surface within a media cartridge, and determining whether the cartridge is inside or outside specified limits, (3) a display generator 903 for generating a warning display; (4) a display device, 904 for example a liquid crystal display device for displaying information to a user concerning the condition of the cartridge as read by read device 900, and (5) an interface 905, which can include a computer readable interface e.g. an SCSI interface, and/or a keypad for enabling scrolling of pre-set menu information on the display 904.

Operation of the read channel can be automatic, or in response to a request entered via user interface 905. The request can be entered either via a keypad, or a remote device, for example a personal computer or the like.

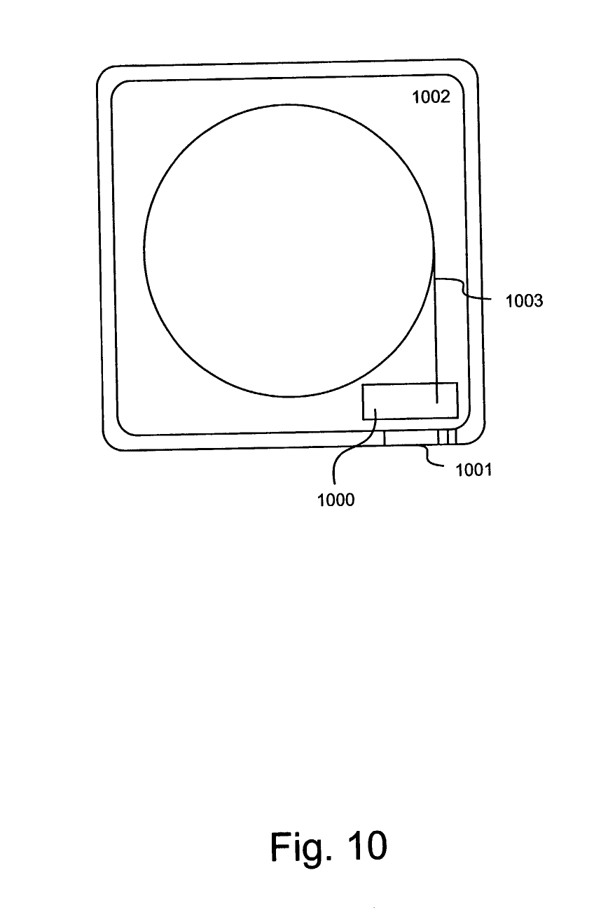

FIG. 10 is a schematic illustration of a media cartridge, in cut away plan view. The media cartridge of FIG. 10 comprises an active sensor device 1000 mounted within the cartridge at a position adjacent an aperture 1001 provided in a casing 1002 of the cartridge, through which a data storage medium 1003, in the form of a magnetic tape, passes into and out of the cartridge.

The sensor embodiments described with the reference to FIGS. 1 to 4 herein are passive sensor devices, capable of being read passively. That is to say, the sensors of FIGS. 1 to 4 do not require any external power supply in order to operate, and do not require any special equipment in order to be read because the human eye or human senses response to the sensors. Temperature sensors can be provided by temperature sensitive strips of material, for example which change color or other physical properties depending upon a temperature reached. Humidity sensors are provided by humidity sensitive strip materials, which change physical property, e.g. color, according to different humidities experienced.

Dust sensors can be provided as dust sensitive strips, of the type described in connection with FIGS. 2 to 4, which require visual comparison with a reference strip to be read, or alternatively which can be read actively.

Passive sensors have no electronic circuit, and rely on the physical and chemical properties of a sensor material to detect out of bound conditions. Two types of passive sensors are (1) those which are human readable without extra test equipment, for example a temperature sensitive strip which changes color according to temperature, and (2) passive sensors which need post event processing in order to determine their status. An example of a second type is testing the luminosity of a sticky strip to measure the amount of dust to which a media cartridge has been exposed.

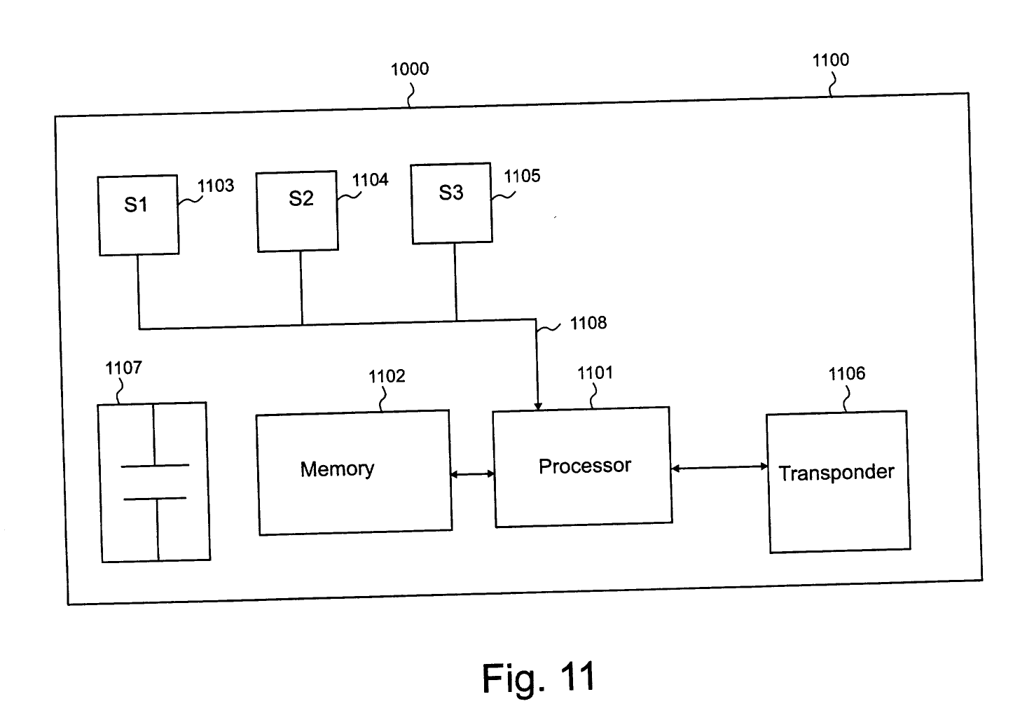

Referring to FIG. 11 herein, the active sensor component 1000 comprises a substrate material 1100, such as circuit board or film substrate, upon which are mounted a plurality of electronic components including a data processor 1101; a non volatile memory device 1102 having read and write capability, one or more sensor devices 1103-1105; a transponder device 1106; and a power supply or storage device 1107, which can take the form of a rechargeable capacitor or a known battery, for example a 10 millimeter diameter lithium battery or the like. The power supply supplies power to the processor 1101, memory 1102, transponder 1106, and sensor devices 1103-1105. Signal bus 1108 couples signals between sensor devices 1103-1105, processor 1101, memory 1102 and transponder 1106.

Examples of sensor devices 1103-1105 are:

(1) A dust sensor, for example a tribo electric sensor device, for sensing atmospheric particles within the media cartridge. Tribo electric devices are known in the art, and one example is described hereinafter.

(2) A humidity sensor, for example a known capacitive humidity sensor, for sensing a humidity condition to which the media cartridge had been exposed.

(3) A temperature sensor, for example a thermocouple or thermistor, for sensing a maximum and/or minimum temperature to which the media cartridge has been exposed.

Sensor devices of the above types of a size suitable for incorporation into a media cartridge are known in the art.

Reading of the memory can be carried out via transponder 1106, in response to insertion of the media cartridge into a port of a data storage device having a read capability as described herein before with reference to FIG. 9.

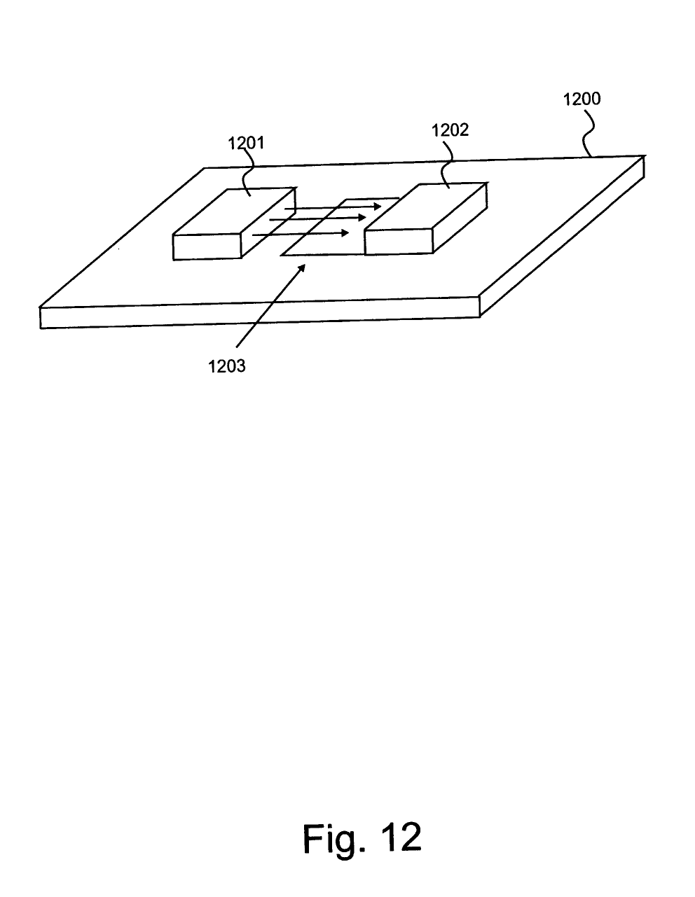

FIG. 12 is a schematic illustration of a tribo electric sensor device for sensing atmospheric particles. The device of FIG. 2 comprises a base plate 1200, a solid state light emitter 1201, for example a light emitting diode; and a solid state sensor 1202, for example a diode detector. Between the light emitter 1201 and light detector 1202, is an air space 1203. Light emitted by light emitter 1201 propagates across the air gap 1203 to be detected by the sensor 1202. Any intervening particles in the atmosphere interfere with the light in gap 1203, and produce optical scattering, such that the intensity of the received light signal incident on sensor 1202 is reduced to produce a corresponding reduced output signal of sensor 1202.

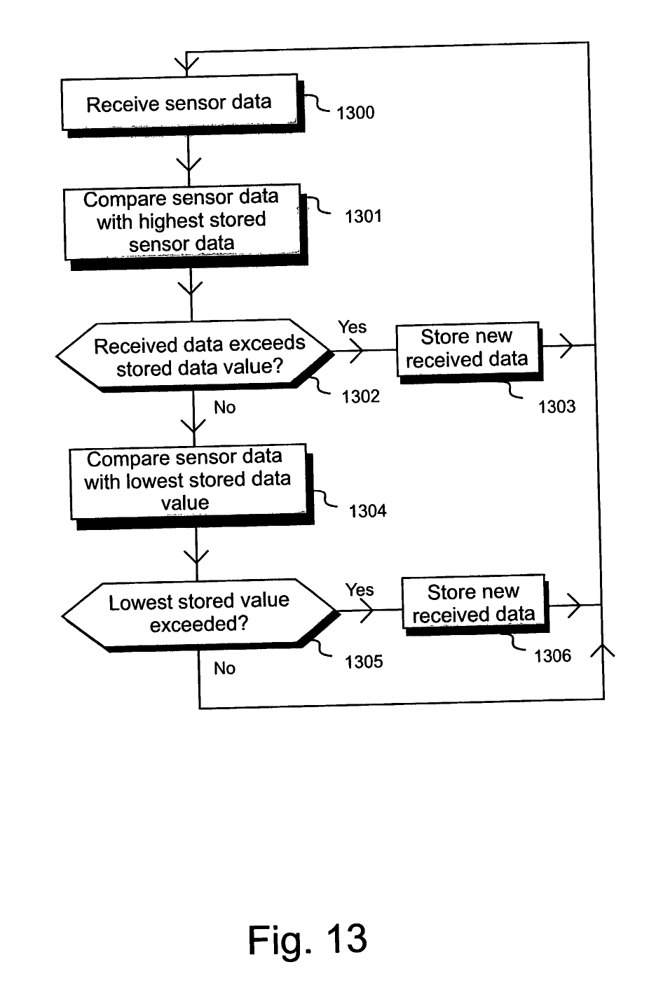

FIG. 13 is a flow diagram of programmed operations of processor 1101 resulting from the output of sensor device 1103-1105 of FIG. 11. The operations of processor 1101 are controlled by stored instructions stored in non volatile memory device 1102. Such instructions can be written in a conventional programming code, such C, C++, or the like, or in a lower level language. Processor 1101 continually polls each of the sensor devices 1103-1105 according to the steps shown in FIG. 13. In step 1300, processor 1101 receives sensor data describing a sensed parameter. In step 1301, the processor compares the value of the received sensor data with stored data values for that particular sensor, as previously stored in memory device 1102. The stored data represent high and low extremes of the sensed environmental parameters. In step 1302, the received data are compared with a highest stored value for that data in memory. If the received data value exceeds the highest previously stored data value, in step 1303, the received data value is stored in memory device 1102, replacing the previous highest stored data value, and becomes a new highest stored data value, representing an extreme of environmental condition e.g. highest temperature. However, if the received sensed data value does not exceed the current highest data value stored in memory, then during step 1304, the received sensor data value is compared with a current lowest previously stored data value in memory 1102 for that particular sensor. The lowest stored current value in memory, represents the lowest extreme which a particular parameter, for example temperature, has been reached. If the currently received sensor data value has a lower value than the stored value in the memory as detected during step 1305, the program advances to step 1306. In step 1306, the currently received sensor data value is stored memory as a new stored value representing the lowest historical value which the data value has reached. However, if the currently received sensor data value is higher than the lowest stored data value, the processor continues to poll the sensor data in step 1300, without storing that data value in memory 1102.

The process of FIG. 13 is carried out for each of different types of sensors 1103-1105 on substrate 1100. For example first sensor 1103 can measure dust particles in the environment, second sensor 1104 can measure temperature, and third sensor 1105 can measure humidity. Stored in memory 1102, are highest and lowest values for each sensor type, representing over an historical period, the highest and lowest extremes of dust environment, temperature and humidity respectively, to which the media cartridge has been exposed.

In addition to storing data read from sensors 1103-1105, memory 1102 can also optionally, store preset maximum and minimum data values for each sensor type, representing pre-calibrated values corresponding to maximum and minimum environmental conditions to which the media cartridge can be exposed within specification, where those conditions can be determined by trial and error experiment at the factory or theoretically.

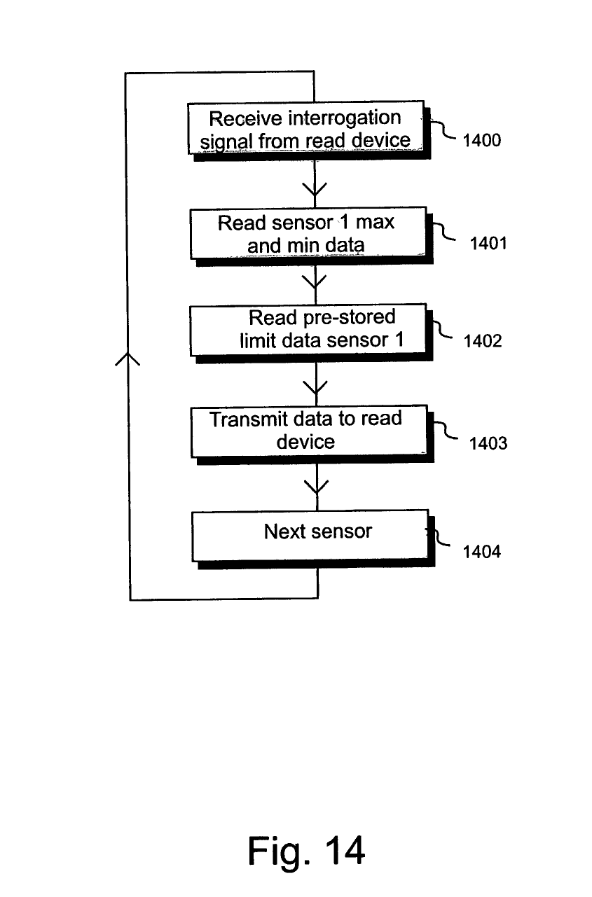

FIG. 14 is a flow diagram of another program for controlling operation of the structures on substrate 1100 in a media cartridge, in response to interrogation by a read device of a tape data storage device as previously described. The read device can comprise a transmitter, which sends a command signal to transponder 1106. The transponder 1106 responds to commands issued by the read channel of the tape data storage device. The sensor component follows process steps as illustrated in FIG. 14 to deliver data values corresponding to the sensor parameters, and optionally, the maximum specified limits stored in memory 1102. In step 1400, the transponder 1106 receives from the read device an interrogation signal to read the memory 1102. In step 1401, in response to the read request, the processor 1101 obtains data from the memory 1102 concerning the maximum and minimum values for a first sensor 1103. In step 1402, the processor 1101 reads from memory 1102 pre-stored predetermined values corresponding to the limit data for that particular sensor. In step 1403, the maximum and minimum data values stored for sensor 1103, together with the predetermined data values, are read from the memory 1102, and are transmitted by transponder 1106 to the read device. At this stage, the read channel of the tape data storage device has, for a first sensor, read the maximum and minimum data values corresponding to maximum and minimum environmental conditions which that sensor has experienced, as well as optionally, predetermined maximum and minimum data values that are pre-programmed into the memory device at the factory, the pre-determined maximum and minimum data values correspond to maximum and minimum specified environmental conditional limits.

In step 1404, the next sensor, for example second sensor 1104 is selected, and the process of FIG. 14 is repeated, delivering maximum and minimum environmental data values for the second sensed parameter, together with optionally, the pre-determined limit values for that environmental sensor, which are pre-stored in the memory 1102.

The process of FIG. 14 continues for each sensor mounted on the substrate 1100, until all data values for all sensors on the substrate have been read by the tape drive unit.

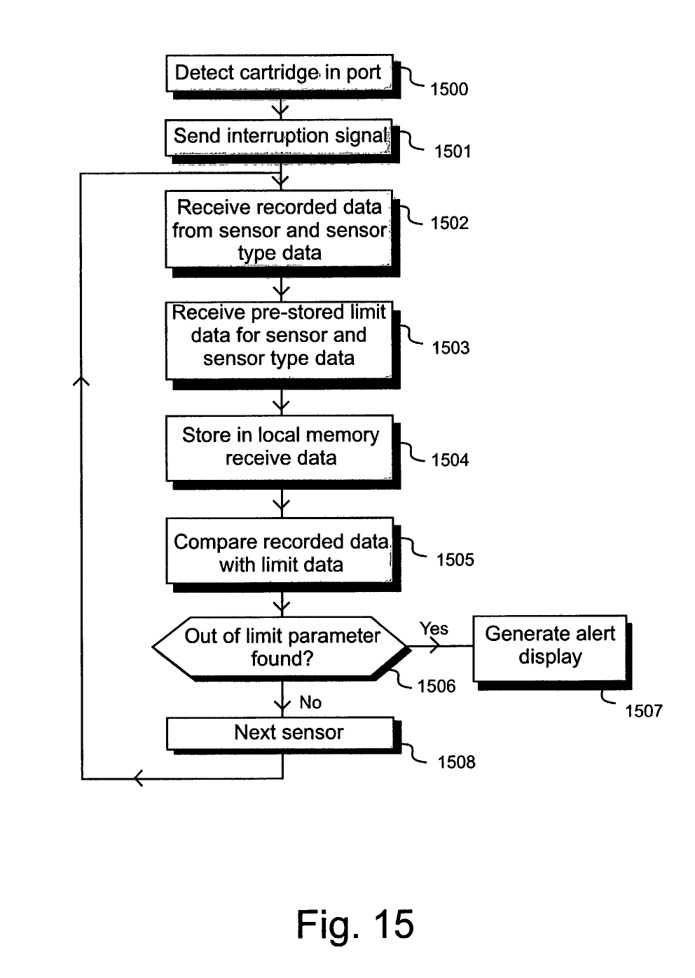

FIG. 15 is a flow diagram of programmed operation for a read channel of a tape drive device as described with reference to FIGS. 7 to 9 herein, upon insertion of a media cartridge carrying a substrate 1100 with active sensors 1103-1105 mounted thereon. During step 1500 a local sensor contained within the port of the tape drive causes the read channel to detect that a cartridge has been inserted. In step 1501, the read device in the tape drive port sends an interrogation signal to the transponder 1106; the interrogation signal requests a download of data describing sensed parameters. In step 1502, the read device receives the maximum and minimum data values sensed by a sensor, together with data describing the type of sensor associated with the values; the sensor is, for example, a humidity sensor, a temperature sensor, or a dust sensor. In step 1503, optionally, pre stored limit data values stored in the memory on the cartridge are downloaded via the transponder 1106, together with data identifying to which type of parameter and/or sensor that the pre-stored limit data corresponds. In step 1504, the read channel stores in local memory 902, the received upper and lower recorded data values, plus the specified limit data values. In step 1505, the processor in the read channel compares the recorded data for the sensor with the limit data for that sensor. In step 1506, a determination is made as to whether a recorded sensor data value is outside the predetermined specified limits. If the determination of step 1506 indicates the recorded value is outside the limits, the program advances to step 1507, during which the display generator 903 generators an alert display signal to be displayed on the display 904 on the casing of the tape drive unit. Such displays can be simple text displays, for example “HIGH TEMPERATURE EXCEEDED”; “LOW TEMPERATURE EXCEEDED”; “HUMIDITY EXCEEDED”; “DUST EXCEEDED”. If, in step 1506 all recorded data parameters are found to be within the predetermined specified limits thereof, the program advances to step 1508, during which the processor downloads data for the next sensor on the component, and steps 1502-1508 are repeated.

It would be appreciated by the person skilled in the art that the steps of FIG. 15 can be carried out as parallel processes or in a different order to that shown. Various alternative implementations are possible as will be appreciated by the person skilled in the art.

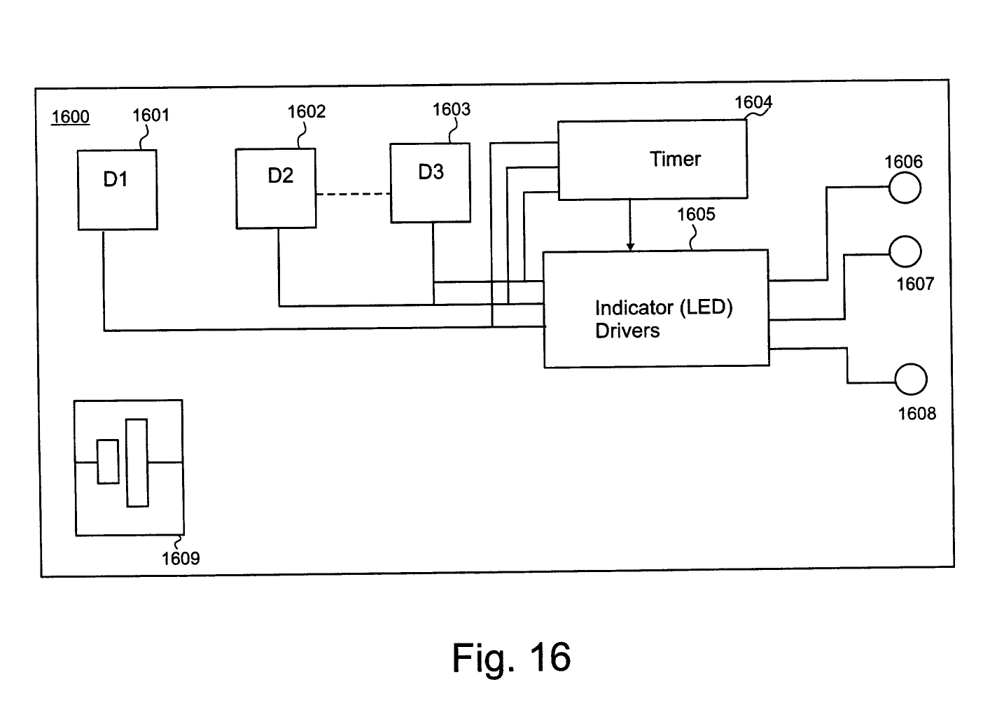

Referring to FIG. 16 herein, there is illustrated schematically an alternative active sensor component including a printed circuit board 1600 contained in a media cartridge.

Printed circuit board 1600 carries (1) three active threshold detectors 1601-1603, for detecting whether threshold conditions have been experienced by the cartridge; (2) a timer 1604, for periodically polling the threshold detectors; (3) a warning indicator driver 1605 for driving three warning indicators 1606-1608, for example light emitting diodes; and (4) a power supply device 1609, for example a battery connected to power the detectors, timer, driver and indicators, as necessary. It is to be understood that the number of detectors and indicators can be greater or less than three.

Active sensor devices, i.e., threshold detectors 1601-1603, are periodically polled by timer 1604. Detectors 1601-1603 respectively drive light emitting diodes 1606-1608 that can be visually inspected by a user.

The component of FIG. 16 can include a plurality of hard wired electronic components mounted on a printed circuit board as shown. Timer 1604 periodically polls threshold detectors 1601-1603. If a condition outside a predetermined condition has been experienced by any one of the threshold detector during the period between adjacent polling of detectors 1601-1603, a signal is sent from the corresponding threshold detector to the indicator driver 1605, which responds to the signal to activate the corresponding warning LED 1606-1608, depending upon which particular threshold detector has been activated. Threshold detectors 1601-1603 detect different sensed parameters, selected from the set temperature, humidity, and air cleanliness (dust).

If an out of limit parameter is sensed, then a visual warning is displayed by a corresponding warning LED for each sensor. The warning LED or LEDs are visible from a position outside the cartridge. In order to save battery power, a timer can periodically activate a warning indicator, rather than having the warning indicator permanently activated. For example, the timer can be set to allow an LED indicator to flash at a pre-determined period, for example every minute, every thirty seconds or whatever period is pre-set. To further save power, the threshold detectors 1601-1603 can be polled at a period pre-set in the timer 1604; the period is selected to provide conservation of battery power.

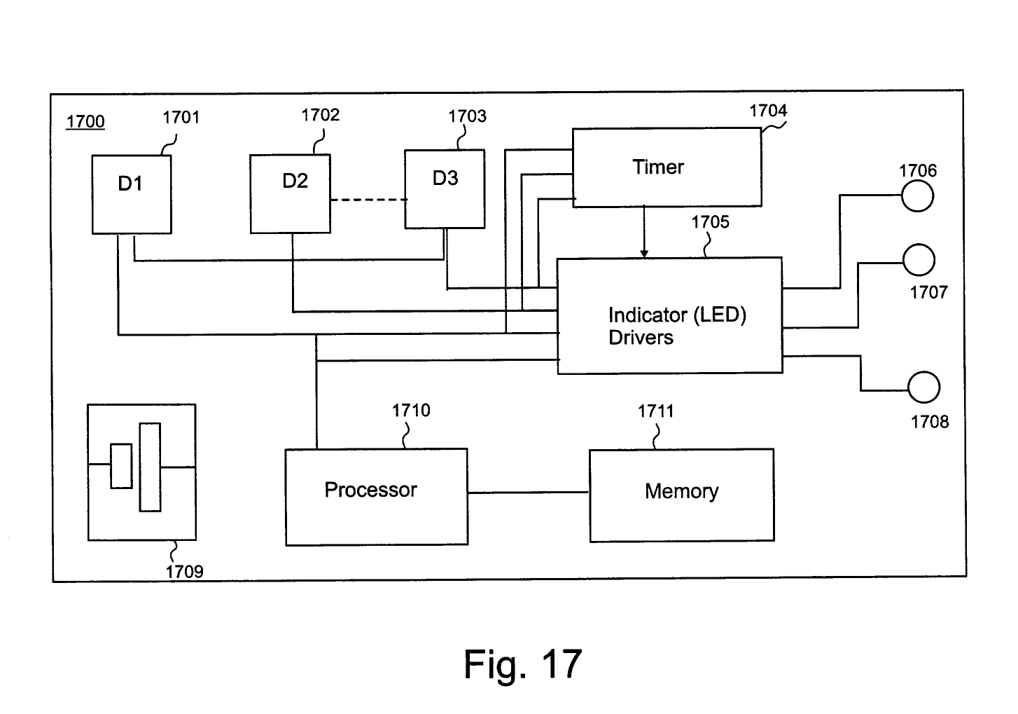

FIG. 17 is a schematic illustration of a further active sensor component that can be employed in the cartridge.

The active sensor component of FIG. 17 comprises (1) a printed circuit board 1700; (2) one or more threshold detectors 1701-1703 for detecting whether an environmental threshold condition has been experienced by a media cartridge into which the sensor component is fitted; (3) a timer 1704 for periodically polling the one or more threshold detectors; (4) a warning indicator driver 1705, for driving one or a plurality of warning indicators 1706-1708, which can be light emitting diodes 1706-1708 or the like; (5) a power supply device 1709, for example a battery or similar device, (6) a processor 1710 as is known in the art, and (7) a memory device 1711 for storing data items corresponding to out of limit environmental conditions which have been recorded by any one or more of the threshold detectors.

The timer 1704 (which in various embodiments can be part of the processor 1710), periodically polls each of the threshold detectors 1701-1703 to check whether those threshold detectors have experienced an out of limit environmental condition, for example excessive heat, excessive humidity, or excessive dust levels. If an out of limit condition is experienced, (1) the indicator driver 1705 generates an immediate warning, for example lighting one of LEDs 1706-1708, and (2) data describing the out of bound condition is stored in the on board memory device 1711.

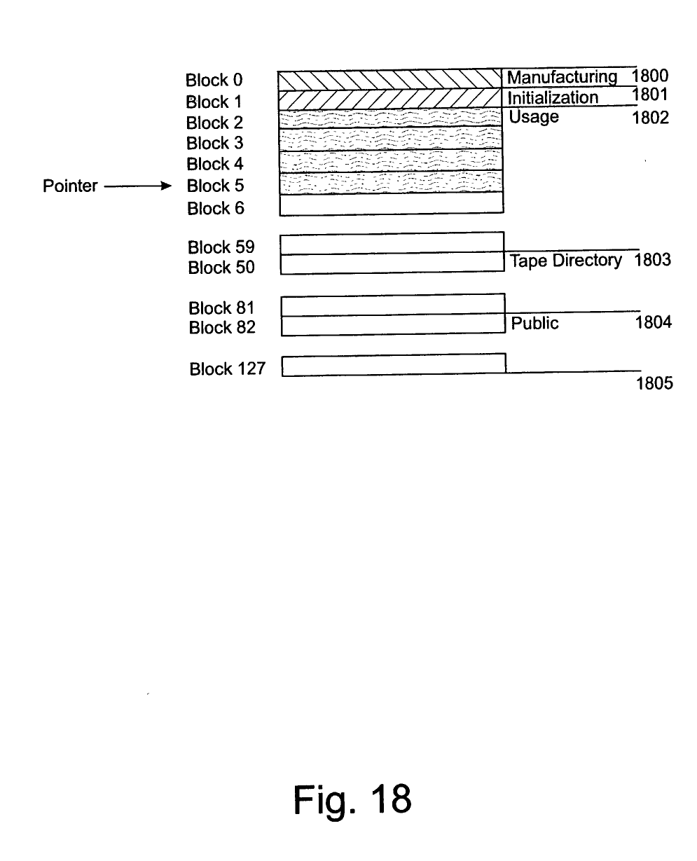

FIG. 18 is a schematic illustration of a logical arrangement of data within memory device 1711. Data are arranged in device 1711 in a plurality of blocks 0-127, each block containing data describing relating to different items concerning the media cartridge; examples of the data are manufacturing data 1800, initialization data 1801, usage data 1802, tape directory data 1803, and public data 1804. One of the 128 blocks is a block 1805 reserved for storage of data collected from the plurality of threshold detectors 1701-1703. In response to an out of limit condition being recorded by any one or more of the threshold detectors 1701-1703, the processor 1710 writes into memory 1711 data representing the occurrence of the out of limit event, and other relevant details, such as time of the event, date of the event, and severity of the out of limit violation. Each occurrence of an out of limit violation is written into memory block 1805 as a separate data item. Each data item can be accessed by a pointer 1606, which points to the item upon reading by the tape drive unit, and downloads the contents of the data block 1805 to the tape drive. By reading the contents of a data block 1805, the tape drive can generate an alarm or alert message, alerting to an out of limit condition having been experienced.

By incorporating an environmental sensor or detector in a media cartridge, which records extreme environmental conditions experienced by the media cartridge wherever the cartridge is stored, an indication of the history and status of the media cartridge can be obtained by reading the sensors. Therefore, sensing of environmental parameters is not restricted to occur when a media cartridge is inserted in a particular data storage device, but sensed parameters relate to environmental conditions experienced over a whole life of a media cartridge.

While the Figs. are concerned with a single reel type media cartridge, in the general case the invention is not restricted to single reel devices, but can be used for other types of data storage media. Examples of such removable data storage media include, but are not limited to: removable magnetic random access memory devices or modules; non volatile removable memory modules; removable disk drives; any data storage medium provided within a cartridge, including twin reel tape data storage media, for example of the digital data storage (DDS) type, or digital audio tape (DAT) type.

While there have been described and illustrated plural specific embodiments of the invention, it will be clear that variations in the details of the embodiment specifically illustrated and described may be made without departing from the true spirit and scope of the invention as defined in the appended claims. For example, certain aspects of the invention can be expanded to detect environmental condition of data storage media other than magnetic tapes, e.g., certain aspects can be used to detect dust on optical compact discs and optical digital video discs, in which case a particle detector is mounted on a disc. In other words, certain aspects of the invention can be used to detect environmental condition of a data storage medium that can be inserted into and removed from a device including a read and/or write transducer for a medium, wherein a sensor arrangement is mounted with respect to the medium so that the medium and sensor undergo substantially the same environmental conditions.

1. A data storage cartridge comprising:
a casing;
a data storage medium; and
a passive sensor, capable of passively sensing a level of environmental particles experienced by said media cartridge.

2. The data storage cartridge as claimed in claim 1, wherein said sensor is arranged so a condition of said passive sensor can change dynamically according to dynamic changing of said environmental particle level, such that a condition of said sensor reflects a current environmental particle condition experienced by said sensor device.

3. The data storage cartridge as claimed in claim 1, wherein said passive sensor device is arranged for recording an extreme environmental particle condition experienced by said passive sensor device, and retaining a physical characteristic according to said extreme physical particle condition experienced, after said extreme physical particle condition has changed.

4. The data storage cartridge as claimed in claim 1, wherein said sensor device can be read passively, without the need for any active interrogation by an external reading instrument.

5. The data storage cartridge as claimed in claim 1, wherein said passive sensor device can be read actively, by an external reading instrument, interrogating said sensor device by use of an interrogation signal.

6. The data storage cartridge as claimed in claim 1, wherein said data storage media comprises an elongate magnetic tape.

7. The data storage cartridge as claimed in claim 1, wherein said data storage media comprises a magnetic random access memory.

8. The data storage cartridge as claimed in claim 1, wherein said data storage media comprises a rotatable magnetic disk.

9. A data storage cartridge comprising:
a casing including:
(a) a data storage media; and
(b) an active sensor component, said active sensor component comprising one or a plurality of active sensor devices, configured for actively sensing an environmental particle condition.

10. The data storage cartridge as claimed in claim 9, wherein said sensor component further comprises:
a plurality of warning indicator devices, said plurality of warning indicator devices being arranged to be activated in response to a said sensor component experiencing an environmental particle condition outside a pre-determined limit.

11. The data storage cartridge as claimed in claim 9, wherein said sensor component comprises:
at least one memory device;
at least one data processor;
said sensor component, memory device and processor being arranged so data describing said environmental particle condition sensed by said sensor component is stored in said memory device, under control of said processor.

12. The data cartridge as claimed in claim 9, wherein said sensor component comprises:
at least one memory device;
at least one data processor;
wherein said memory device is remotely interrogatable by an external reading instrument, to read stored data from said memory device.

13. A data storage cartridge comprising:
a casing;
a data storage medium; and
a reflective adhesive surface located inside a cavity of said casing, said cavity including said data storage medium, said reflective adhesive surface being viewable from a position outside said casing.

14. The cartridge as claimed in claim 13, wherein said reflective adhesive surface comprises:
a reflective component capable of reflecting light;
a substantially transparent adhesive component, capable of transmitting light.

15. The cartridge as claimed in claim 13, wherein said reflective adhesive surface is capable of adhering particles having a maximum dimension in the range 20 microns, to 1 millimeter.

16. The cartridge as claimed in claim 13, wherein said reflective adhesive surface comprises a reflective adhesive layer deposited on an interior surface of said casing, at a position adjacent an aperture in said casing.

17. A reference device for indicating a dust exposure condition of a medium cartridge including a storage medium, said reference device comprising:
a substrate material;
a reflective material, said reflective material having a reflective region, of differing reflectivities such that at a first position of said region, an area of maximum reflectivity is provided, and at a second position of said region an area of minimum reflectivity is provided; and
a set of scale markings arranged adjacent said reflective region, such that a user can visually compare an area of said reflective material, with said scale markings to make a reading of said scale markings corresponding to a visually selected reflectivity.

18. The reference indicator as claimed in claim 17, comprising a plurality of reflective regions which are visually distinct from each other in a quantized manner.

19. The reference indicator as claimed in claim 17, wherein said reflective region comprises a region of smoothly graded changing reflectivity.

20. A linear tape data storage device comprising:
a port capable of receiving a media cartridge and locating said media cartridge therein;
a read device positioned adjacent said port, said reading device being capable of sending a signal towards said media cartridge when said media cartridge is in situ in said port, and capable of receiving a return signal from said media cartridge, said return signal containing information describing at least one sensed parameter of said media cartridge; and
a read channel for receiving said return signal, and extracting data describing said sensed parameter from said return signal.

21. The data storage device as claimed in claim 20, wherein said read channel comprises;
at least one data processor; and
at least one memory device for storing data describing said sensed parameter.

22. The data storage device as claimed in claim 21, wherein said read channel further comprises:
a display generator for generating display signals suitable for display on a display device, said display signals containing said information describing said sensed parameter.

23. The data storage device as claimed in claim 20, further comprising:
an interface for accessing stored data describing at least one sensed parameter of a data storage cartridge.

24. A data storage device as claimed in claim 20 comprising:
a menu driven display, operable by a user to select a predetermined parameter for sensing, and capable of displaying information describing said sensed parameter on said display device.

25. A method of assessing a condition of a cartridge including a storage medium, said method comprising:
viewing a reflective sensor on the cartridge, the sensor having a reflectivity that varies depending upon a measured environmental particle parameter; and
comparing the viewed reflectivity with at least one reference reflectivity.

26. A data storage medium cartridge comprising:
a casing; and
an active sensor component capable of sensing and storing historical data describing environmental conditions experienced by the cartridge.

27. The cartridge as claimed in claim 26, wherein said sensor component comprises:
at least one sensor device;
at least one data processing device;
at least one memory device; and
a transmitter for transmitting a signal describing a parameter sensed by said sensor device.

28. The cartridge as claimed in claim 26, wherein:
said at least one sensor device is arranged for generating a signal corresponding to a sensed environmental parameter; and
said memory device being arranged to store said environmental parameter signal.

29. The cartridge as claimed in claim 26, wherein:
said memory device is arranged for storing data (a) describing predetermined data values for an environmental condition, and (b) describing a specified minimum and/or maximum environmental condition to be encountered by said cartridge.

30. The cartridge as claimed in claim 26, wherein a said sensor device comprises a device selected from the set;
a humidity sensor; and
a dust particle sensor.

31. A data storage cartridge comprising:
a casing;
a data storage medium; and
a sensor device, adjacent data storage medium, the sensor device being within said casing and being capable of sensing an environmental parameter to which said medium cartridge is exposed, said sensor being selected from the set:
a magnetic field sensor; and
a dust particle sensor.

32. The cartridge as claimed in claim 31, wherein said sensor is capable of being read from a position outside said casing.

33. The cartridge as claimed in claim 31, wherein said sensor is arranged to change reflectivity in response to said environmental parameter.

34. A data storage cartridge comprising:
a casing;
a data storage medium; and
a passive sensor, capable of passively sensing a level of environmental magnetism experienced by said media cartridge.

35. The data storage cartridge as claimed in claim 34, wherein said sensor is arranged so a condition thereof changes dynamically according to a dynamic change of said environmental magnetic level, such that a condition of said sensor reflects a current environmental magnetic condition experienced by said sensor.

36. The data storage cartridge as claimed in claim 34, wherein said sensor is arranged for (a) recording an extreme environmental magnetic condition experienced by said sensor, and (b) retaining a physical characteristic according to said extreme magnetic condition experienced, after said extreme magnetic condition has changed.

37. The data storage cartridge as claimed in claim 34, wherein said sensor is arranged to (a) sense passively, and (b) read passively, without the need for any active interrogation by an external reading instrument.

38. The data storage cartridge as claimed in claim 34, wherein said passive sensor can be (a) read actively, by an external reading instrument, and (b) interrogated by an interrogation signal.

39. The data storage cartridge as claimed in claim 34, wherein said data storage media comprises an elongated magnetic tape of a linear tape open (LTO) format.

40. The data storage cartridge as claimed in claim 33, wherein said data storage medium comprises a magnetic random access memory.

41. The data storage cartridge as claimed in claim 33, wherein said data storage medium comprises a rotatable magnetic disk.

42. A data storage cartridge comprising:
a casing;
a data storage medium; and
an active sensor component, said sensor component comprising one or a plurality of sensor devices, configured for actively sensing at least one environmental condition.

43. The data storage cartridge as claimed in claim 42, wherein said sensor component comprises:
at least one memory device;
at least one data processor;
said memory device, data processor and sensor component being arranged so data describing said environmental condition sensed by said sensor component are stored in said memory device, under control of said processor.

44. The data cartridge as claimed in claim 42, wherein said memory device is remotely interrogatable by an external reading instrument, to read said stored data.

45. A linear tape data cartridge comprising:
a casing;
a linear tape data storage medium; and
a passive sensor, capable of passively sensing a level of at least one environmental condition experienced by said linear tape data storage medium within said cartridge.

46. The reference device as claimed in claim 17, wherein the differing reflectivities are arranged spatially substantially linearly.

47. The method as claimed in claim 25, wherein the viewed reflectivity is compared with plural levels of reflectivity, and determining from a look up table, a condition of said media cartridge, said look up table tabulating media cartridge condition, against reflectivity of said sensor device as determined from the comparing step.

48. A method of assessing a condition of a cartridge including a storage medium, said method comprising:
viewing a reflective sensor on the cartridge, the sensor having a reflectivity that varies depending upon a measured environmental particle parameter; and
determining from a look up table a condition of said media cartridge, said look up table including a tabulation of media cartridge condition against reflectivity of said sensor device as determined from the viewing step.

49. A method of assessing a condition of a cartridge including a storage medium, said method comprising:
viewing a reflective sensor on the cartridge, the sensor having a reflectivity that varies depending upon environmental particles and incident on the cartridge,
correlating reflection from the sensor with an indication of cartridge condition.

50. Apparatus for enabling detection of environmental condition of a data storage medium that can be inserted into and removed from a device including a read and/or write transducer for a medium, the apparatus including a sensor arrangement for the environmental condition, the sensor arrangement being mounted with respect to the medium so that the medium and the sensor undergo substantially the same environmental conditions.

51. An apparatus in accordance with claim 50 wherein the sensor arrangement includes a particle detector.

52. An apparatus in accordance with claim 50 wherein the sensor arrangement includes a temperature detector.

53. An apparatus in accordance with claim 50 wherein the sensor arrangement includes a humidity detector.

54. An apparatus in accordance with claim 50 wherein the sensor arrangement includes a magnetic field detector.

55. An apparatus in accordance with claim 50 further including an output device associated with the sensor arrangement for enabling an indication of an environmental condition sensed by the sensor arrangement to be derived.

56. An apparatus in accordance with claim 55 wherein the output device is arranged for supplying the signal to an indicator.

57. An apparatus in accordance with claim 55 wherein the sensor is arranged to provide a human readable visual indication, the output device including reference human readable visual indicia for enabling a human to correlate the human readable visual indication with the human readable visual indicia.

58. An apparatus in accordance with claim 57 wherein the human readable visual indication and the human readable visual indicia are color.
